(19) United States
(12) Patent Application Publication
(10) Pub. No.: US 2024/0294803 A1
(43) Pub. Date: Sep. 5, 2024

(54) UV WAX COMPOSITION AND USES THEREOF

(71) Applicant: Jason B. Mills, Lakewood, CO (US)

(72) Inventor: Jason B. Mills, Lakewood, CO (US)

(21) Appl. No.: 18/593,363

(22) Filed: Mar. 1, 2024

Related U.S. Application Data
(60) Provisional application No. 63/576,700, filed on Mar. 1, 2023.
(60) Provisional application No. 63/452,733, filed on Apr. 23, 2023.

(51) Int. Cl. C09G 3/00; C10M 109/00; C10M 125/02; C10N 50/08

(52) U.S. Cl. CPC C09G 3/00; C10M 109/00; C10M 125/02; C10M 2201/041; C10M 2205/183; C10N 2050/08

(57) ABSTRACT

The present disclosure relates to curable wax compositions comprising a natural wax, a drying oil, and a terpene compound. Such compositions may further include a UV catalyst or at least one additive. Disclosed compositions are free from fluorinated compounds, such as per-and polyfluoroalkyl substances (PFAS) and other environmentally harmful chemicals. Also included are methods for producing and using such compositions.

### CROSS-REFERENCE TO RELATED APPLICATION

The present application claims priority to U.S. Provisional Application No. 63/576,700, filed on Mar. 1, 2023, and entitled “UV BONDING WAX,” and U.S. Provisional Application No. 63/452,733, filed on May 3, 2023, and entitled “UV SNOWBOARD AND SKI WAX,” the entire disclosures of which are expressly incorporated by reference herein.

### FIELD OF THE INVENTION

The present disclosure relates in some aspects to wax compositions. In particular, the present disclosure relates to curable wax compositions. The present disclosure further relates to methods of preparing such compositions and uses thereof, e.g., applying the compositions to snow and water sport equipment and altering the gliding/sliding properties of the same.

### BACKGROUND

Sealing the bases of winter and water sports equipment, such as skis and snowboards, with a suitable wax can extend the lifespan of the equipment and alter the grip and glide of the equipment on a surface, such as snow or water. However, many commercially available waxes contain persistent and hazardous environmental contaminants, such as per-and polyfluoroalkyl substances (PFAS). Such compounds, particularly fluorocarbons, can abrade at high levels onto snow and potentially contaminate soil and groundwater. Improved compositions are needed, e.g., to provide high-performing options that are environmentally friendly and reduce PFAS pollution. Provided are embodiments that meet such needs.

### INCORPORATION BY REFERENCE

Each patent, publication, and non-patent literature cited in the application is hereby incorporated by reference in its entirety as if each was incorporated by reference individually, and as if each is fully set forth herein. However, where such reference is made, and whether to patents, publications, non-patent literature, or other sources of information, it is for the general purpose of providing context for discussing features of the invention. Accordingly, unless specifically stated otherwise, the reference is not to be construed as an admission that the document or underlying information, in any jurisdiction, is prior art, or forms part of the common general knowledge in the art.

### SUMMARY OF THE INVENTION

In some aspects, provided herein is a curable wax composition, such as a curable ski wax. In some embodiments, provided is a curable wax composition including a drying oil, a monoterpene compound, and a natural wax, where the composition includes the natural wax in an amount of 45-85% w/w relative to the total composition. In some of any embodiments, the monoterpene compound may be omitted from the composition.

In some of any embodiments, the composition further includes a UV catalyst and/or an MEKP catalyst.

In some of any embodiments, the drying oil includes linseed oil, soybean oil, safflower oil, tung oil, or a combination thereof.

In some of any embodiments, the natural wax includes beeswax, soy wax, bayberry wax, candelilla wax, carnauba wax, castor wax, vegetable wax, ouricury wax, rice bran wax, or lanolin.

In some of any embodiments, the composition includes a natural wax blend.

In some of any embodiments, the natural wax blend includes a wax with a melting point of 145° F. to 200° F., wherein the range is inclusive.

In some of any embodiments, the monoterpene compound includes camphor, citral, citronellol, geraniol, grapefruit mercaptan, eucalyptol, ocimene, myrcene, limonene, linalool, menthol, camphene, or pinene.

In some embodiments, provided is a curable wax composition including a) 10-15% (w/w) tung oil; b) 55-80% (w/w) of a natural wax blend; c) 10-15% (w/w) limonene; and d) 1-5% (w/w) of a UV catalyst.

In some of any embodiments, the natural wax blend includes any two or more of beeswax, soy wax, bayberry wax, candelilla wax, carnauba wax, castor wax, vegetable wax, ouricury wax, rice bran wax, and lanolin.

In some of any embodiments, the natural wax blend includes beeswax, soy wax, and carnauba wax.

In some of any embodiments, the composition further includes graphene, graphene oxide, graphite, or a combination thereof.

In some of any embodiments, the composition does not comprise per-and polyfluoroalkyl substances (PFAS).

In some of any embodiments, the composition can be used as a ski wax, outerwear wax, footwear wax, upholstery wax, animal hide wax, or a synthetic hide wax.

In some aspects, provided herein are methods of manufacturing a curable wax composition. In some embodiments, manufacturing a curable wax composition includes a) heating a mixture of a natural wax or a natural wax blend, a drying oil, and a monoterpene to a temperature of 170° F. or higher, 180° F. or higher, or 190° F. or higher but no higher than 200° F., 215° F., 225° F., or 250° F., and b) cooling the mixture to a temperature ranging from 140° F.-160° F., 150° F.-165° F., 140° F.-155° F., 130° F.-155° F., or 120° F.-155° F. In some embodiments, the method further includes adding a UV catalyst and/or an MEKP catalyst to the cooled mixture.

### DETAILED DESCRIPTION

In some aspects, provided herein are compositions, such as curable wax compositions, comprising a drying oil, a natural wax, and a terpene compound. Such compositions provide various advantages due to their enhanced properties, ranging from improved application to surfaces, such as a wooden or synthetic surface, to altered grip and gliding properties, e.g., when sliding on water and snow. Advantages also include restoration, protection, and improved durability of the surfaces, as well resistance to harsh weather conditions. The combination provides high polymer chains to allow for improved UV Reactions and other chemical reactions usually only found in manufactured petrochemicals. Additionally, disclosed compositions are free from environmentally harmful fluorinated compounds, such as per-and polyfluoroalkyl substances (PFAS) and other hazardous chemicals.

When skis or snow sport equipment gains speed, friction melts the snow and turns the snow into water. A drying oil, alternatively referred to as a hardening oil, can repel water or waterproof the surface of the snow sport equipment that contacts snow and water. Drying oils harden when exposed to oxygen, and UV curing can be used to help solidify the drying oil faster. In one example, a disclosed curable wax composition comprising a drying oil, such as tung oil, and hard, high melt waxes, e.g., having a melting point in the range of 145-180° F., improves the glide and durability of a surface, while reducing its wear, slip, icing, and contaminate uptake, across a wide range of temperatures and conditions. Ease of application and penetration into the desired surface is also greatly improved with the inclusion of a drying oil.

Exemplary drying oils harden to a tough, solid film after exposure to air. Although the “drying” or curing mechanism depends on oxygen, the process can be accelerated by UV light, whether naturally occurring or from a UV lamp. The principal film-forming reaction of drying oils is oxidation, which includes isomerization, polymerization, and cleavage. These reactions can be catalyzed by dryers such as zirconium, cobalt, and manganese (organometallic salts). For example, the components of drying oils can cross-link and polymerize by the action of oxygen in the presence of an oxidation promotor or UV catalyst. Drying oils such as linseed, soybean, and safflower oils have cis-methylene-interrupted unsaturation, whereas other drying oils, such as tung oil, contain conjugated double bonds. Disclosed compositions comprising drying oil provide the advantage of repelling water or water-proofing a surface, such as the base of snow sport equipment, e.g., skis. As the base of skis or a snowboard gain speed across snow, friction melts the snow thereby exposing the equipment to water.

An exemplary source of a drying oil is tung (Vernicia fordii), a small-to medium-sized deciduous tree belonging to the Euphorbecaeae family. It is native to countries such as China, Burma, and Vietnam. Tung oil is typically extracted from the nuts of the tung tree. The oil content in the nut is approximately 30-40 wt %. Tung oil contains a high content of unsaturated fatty acids. The unsaturated fatty acids present in tung oil include eleostearic acid, linoleic acid, and oleic acid, and the saturated fatty acids present are palmitic acid and stearic acid. Tung oil also contains other fatty acids such as behenic acid, eicosenoic acid, and heneicosanoic acid. See, e.g., Moser, In Vitro Cell Dev Biol Plant. 2009;45(3):229-66 and Sandesh et al., “Prospective ecofuel feedstocks for sustainable production.” Advances in Eco-Fuels for a Sustainable Environment, 89-117.

In some embodiments, the drying oil may include linseed oil, soybean oil, safflower oil, tung oil, walnut, almond, olive, coconut oil or a combination thereof. In some embodiments, the drying oil is linseed oil, soybean oil, safflower oil, or tung oil. In preferred embodiments, the drying oil is tung oil. In some embodiments, the tung oil is pure tung oil, heat-treated tung oil, pre-polymerized tung oil, or polymerized tung oil.

In some embodiments, disclosed compositions, such as curable wax compositions, comprise 0.1-20%, 0.1-15%, 0.1-10%, 0.1-5%, 1-20%, 1-15%, 1-10%, 1-5%, 5-20%, 5-15%, 5-10%, 10-30%, 10-25%, 10-20%, 1-25%, 5-20%, or 10-15% of the drying oil. In some embodiments, disclosed compositions comprise about 5%, 6%, 7%, 8%, 9%, 10%, 11%, 12%, 13%, 14%, 15%, 16%, 17%, 18%, 19%, or 20% of the drying oil. The amount of the drying oil is provided as a weight percentage relative to the weight of the total composition (w/w %).

Exemplary natural waxes are derived from an animal or a plant. In other examples, the natural wax can be semi-synthetic wax. In some embodiments, a disclosed curable wax composition comprises a natural wax or a natural wax blend, such as a mixture of natural waxes.

In some embodiments, the natural wax has a melting point of about ≥145° F. (≈≥63° C.), ≥150° F. (≈≥66°° C.), ≥155° F. (≈≥68° C.), ≥160° F. (≈≥71° C.), ≥165° F. (≈≥74° C.), ≥170° F. (≈≥77° C.), ≥175° F. (≈≥79°° C.), or ≥180° F. (≈≥82° C.). In some embodiments, the natural wax has a melting point within the range of 145-185° F., 145-200° F., 145-225° F., 150-185° F., 150-200° F., 150-225° F., 165-185° F., 165-200° F., or 165-225° F., wherein each range is inclusive.

In some embodiments, the natural wax blend comprises at least one natural wax that has a melting point of ≥145° F. (≈≥63° C.), ≥150° F. (≈≥66° C.), ≥155° F. (≈≥68° C.),≥160° F. (≈≥71° C.), ≥165° F. (≈≥74° C.), ≥170° F. (≈≥77° C.), ≥175° F. (≈≥79° C.), or ≥180° F. (≈≥82° C.). In some embodiments, the natural wax blend comprises at least one natural wax that has a melting point within the range of 145-185° F., 145-200° F., 145-225° F., 150-185° F., 150-200° F., 150-225° F., 165-185° F., 165-200° F., or 165-225° F., wherein each range is inclusive.

In some embodiments, the natural wax includes processed or unprocessed; soy wax, ibota wax, cocoa/cacao butter, kapok wax, kaya oil, carnauba wax, castor wax, ouricury wax, candelilla wax, beef tallow, hydrogenated beef tallow, spermaceti wax, sugar cane wax, shea butter, jojoba wax, shellac wax, lard, rice bran wax, horse fat, palm wax, bayberry wax, hydrogenated jojoba ester, beeswax, cotton wax, Japanese wax, Japanese wax kernel oil, or montan wax.

In some embodiments, the natural wax blend comprises at least two waxes selected from soy wax, ibota wax, cocoa/cacao butter, kapok wax, kaya oil, carnauba wax, castor wax, candelilla wax, beef tallow, hydrogenated beef tallow, spermaceti wax, sugar cane wax, shea butter, jojoba wax, shellac wax, lard, rice bran wax, horse fat, palm wax, bayberry wax, hydrogenated jojoba ester, beeswax, cotton wax, Japanese wax, Japanese wax kernel oil, and montan wax.

In some embodiments, the natural wax blend consists essentially of 2, 3, 4, 5, 6, 7, or 8 natural waxes. In preferred embodiments, the natural wax blend comprises soy wax, beeswax, carnauba wax, or a combination thereof. In further preferred embodiments, the natural wax blend comprises In preferred embodiments, the natural wax blend consists essentially of or consists of soy wax, beeswax, and carnauba wax.

In some embodiments, the natural wax blend comprises equivalent amounts of each wax that composes the blend, such as equivalent weights or volumes. For example, a wax blend consisting of two waxes has a simplified weight-by-weight ratio or volume-by-volume melt ratio of 1:1, a wax blend consisting of three waxes has a simplified weight-by-weight ratio or volume-by-volume melt ratio of 1:1:1, a wax blend consisting of four waxes has a simplified weight-by-weight ratio or volume-by-volume melt ratio of 1:1:1:1, and so forth. In other embodiments, the natural wax blend comprises different amounts of each natural wax that composes the natural wax blend, such as distinct weights or volumes of each wax in the natural wax blend.

In some embodiments, disclosed compositions comprise the natural wax or the natural wax blend in a total amount (w/w %) of about 45-95%, 50-95%, 55-95%, 60-95%, 65-95%, 70-95%, 75-95%, 50-90%, 50-90%, 55-90%, 60-90%, 65-90%, 70-90%, 75-90%, 45-85%, 50-85%, 55-85%, 60-85%, 65-85%, 70-85%, 75-85%, 50-80%, 55-75%, 65-85%, 70-80%, 25-80%, 30-80%, 35-80%, 40-80%, 45-80%, 50-80%, 55-80%, 60-80%, 65-80%, 70-80%, 75-80%, 25-75%, 30-75%, 35-75%, 40-75%, 45-75%, 50-75%, 55-75%, 60-75%, 65-75%, 70-75%, 25-70%, 30-70%, 35-70%, 40-70%, 45-70%, 50-70%, 55-70%, 60-70%, 65-70%, 25-65%, 30-65%, 35-65%, 40-65%, 45-65%, 50-65%, 55-65%, or 60-65%, wherein each range is inclusive.

In some embodiments, disclosed compositions comprise the natural wax or the natural wax blend in a total amount (w/w %) of about 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, or 85%. The amount of the natural wax or natural wax blend is provided as a weight percentage relative to the weight of the total composition (w/w %).

In some embodiments, disclosed compositions comprise a terpene compound. In other embodiments, disclosed compositions do not include a terpene compound. Exemplary terpenes are aromatic compounds found in many plants. Commonly, terpenes are present in natural oil extracts, e.g., the essential oil extract of a plant or a fruit, such as a Citrus fruit. Citrus is a genus belonging to the Rutaceae family and includes important crops like orange, lemons, pummelos, grapefruits, limes, etc. Citrus essential oils include major biologically active compounds like α-/β-pinene, sabinene, β-myrcene, d-limonene, linalool, a-humulene, and a-terpineol belonging to the monoterpenes, monoterpene aldehyde/alcohol, and sesquiterpenes group, respectively.

In some embodiments, the terpene includes camphor, citral, citronellol, geraniol, grapefruit mercaptan, eucalyptol, ocimene, myrcene, limonene, linalool, menthol, camphene, or pinene. In some embodiments, disclosed compositions comprise a terpene blend, such as at least two terpenes selected from the group consisting of camphor, citral, citronellol, geraniol, grapefruit mercaptan, eucalyptol, ocimene, myrcene, limonene, linalool, menthol, camphene, and pinene.

In some embodiments, the terpene is a monoterpene. In preferred embodiments, the terpene is a cyclic monoterpene. In further preferred embodiments, the terpene includes d-limonene or r-limonene such as pure, >90%, >95%, or >99% limonene.

In some embodiments, the terpene is present in a total amount, such as a total volume, which is equivalent or approximately equivalent to the total volume of the drying oil in the disclosed composition. In some embodiments, the terpene is present in a total amount, such as a total volume which is distinct or significantly different from the total volume of the drying oil in the disclosed composition.

In some embodiments, disclosed compositions further comprise an ultraviolet (UV) catalyst, such as a catalyst for UV curing. Herein, a “UV catalyst” may also be referred to as a “UV curing agent.” In some embodiments, the UV catalyst is a benzophenone derivative, a thioxanthone, an acylphosphine oxide, titanium dioxide, or a combination thereof. In other embodiments, disclosed compositions further comprise a methyl ethyl ketone peroxide (MEKP) catalyst.

In some embodiments, a curable wax composition comprises a drying oil in a (w/w) amount of about 1-25%, 5-20%, or 10-15%, a natural wax or a natural wax blend in a total amount (w/w) of about 55-75%, 65-85%, or 70-80%, and a terpene in a total amount (w/w) of 1-25%, 5-20%, or 10-15%. In some embodiments, the curable wax composition further comprises 0.1-5%, 0.5-5%, or 1-5% (w/w) of a UV catalyst and/or an MEKP catalyst.

In some embodiments, a curable wax composition comprises a drying oil in a total amount (w/w %) of about 5%, 6%, 7%, 8%, 9%, 10%, 11%, 12%, 13%, 14%, or 15%, a natural wax blend in a total amount (w/w %) of about 65%, 66%, 67%, 68%, 69%, 70%, 71%, 72%, 73%, 74%, 75%, 76%, 77%, 78%, 79%, 80%, 81%, 82%, 83%, 84%, or 85%, and a terpene in a total amount (w/w %) of about 5%, 6%, 7%, 8%, 9%, 10%, 11%, 12%, 13%, 14%, or 15%. In some embodiments, the curable wax composition further comprises 0.5%, 1%, 1.5%, 2%, 2.5%, 3%, 3.5%, 4%, 4.5%, 5% (w/w %) in total of a UV catalyst and/or an MEKP catalyst. The amount of the drying oil is provided as a weight percentage relative to the weight of the total composition (w/w %).

In some embodiments, disclosed compositions further comprises at least one additive. In some embodiments, the at least one additive is present in a total amount (w/w %) of about 0.1-10%, 0.1-5%, 0.1-1%, 0.5-10%, 0.5-5%, 0.5-1%, 1-10%, or 1-5% of the total composition. In some embodiments, the additive includes a cosmetic enhancer, a colorant, a dye, a pigment, glitter, or a scent. In some embodiments the additive is selected from the group consisting of a natural resin, e.g., rosin or dammar resin, a natural rubber, e.g., as a latex-based rubber or a non-latex based rubber, a synthetic rubber, such as poly-iso-butylene (PIB), graphene, graphene oxide, graphite, molybdenum disulfide, tungsten disulfide, silica particles, diamond particles/powder, a synthetic high polymer, e.g., poly-methacrylic acid ester, polyiso-butylene, ethyl vinyl acetate (EVA), a dye, a colorant, or a combination thereof. In some examples, such additives improve the strength, elasticity, stability, glide, grip, or appearance of the composition.

Exemplary additives are used to mitigate electrostatic resistance, e.g., graphite and derivatives thereof, such as graphene oxide and/or graphene. In one example, graphite can serve as an electric conductor that allows disclosed wax compositions to shed electrostatic pull from the snow. In other examples, graphene oxide improves the release of electrons and graphene, as a super conductor, further increases electrostatic resistance. Such compounds may also be used as lubricants. When cured in UV light, e.g., under sunlight or any artificial light source having a wavelength in the range of 400 to 900 nm, the oxygen molecule in graphene oxide is released and graphene is formed, further enhancing glide, durability, wear, slip, icing, and resistance to contaminate uptake.

In some embodiments, the additive includes graphene, graphene oxide, graphite, or a combination thereof. Graphite is composed of planar sheets of carbon atoms arranged in a honeycomb lattice and stacked in layers. One atomic layer of graphite is referred to as graphene. Accordingly, graphene has a two-dimensional structure while graphite has a three-dimensional structure. Thus, graphene is crystalline allotrope of carbon where the carbon atoms are packed in a regular sp2-bonded hexagonal pattern. Any form of graphene may be included in disclosed compositions. In some embodiments, disclosed compositions comprise graphene with a residual oxygen content of 5-20%. In one example, the graphene additive may be prepared from graphene oxide by thermal reduction, such as according to the method of Wang et al., Chem. Commun., 2012;48:976-978.

In some of any embodiments, disclosed compositions do not comprise fluorinated compounds, such as per-and polyfluoroalkyl substances (PFAS) and other hazardous chemicals. In some of any embodiments, disclosed compositions do not comprise perfluorinated sulfonic acids (PFSAs), perfluorinated carboxylic acids (PFCAs), 6:2 fluorotelomer sulfonic acid (GenX), perfluorooactanoic acid (PFOA), perfluorooctanesulfonic acid (PFOS).

Exemplary methods of manufacturing disclosed compositions, such as curable wax compositions include heating wax and oil ingredients together and mixing until a uniform blend is achieved. In some examples, the mixture is heated to about 160-212° F. (≈71-100° C.), 170-212° F. (≈77-100°° C.), or 180-212° F. (≈82-100° C.), wherein each range is inclusive. In some examples, the mixture is then cooled for the addition of other ingredients. The mixture may be cooled to about 100-150° F. (≈38-66°° C.), 120-165° F. (≈49-74° C.), or 130-170° F. (≈54-77° C.). In some examples, UV curing agent(s) and additive(s) are added to the composition upon cooling. The final wax compositions may then be processed and packaged according to known methods.

Exemplary methods of manufacturing disclosed compositions comprising the additive graphene oxide include mixing graphene oxide, such as graphene oxide suspended in water via a modified Hummers method, with a natural wax/natural wax blend and heating until the wax melts. The wax will bond to the graphene oxide in solution. The wax is then dried and the water is poured off. If still present, graphite is retained by the water and poured off when the wax cools.

Exemplary methods of using disclosed compositions include applying such compositions to a surface. In some examples, the surface is a material comprising wood. In some embodiments, the wood is ash, bamboo, beech, birch, fir, maple, poplar, paulownia, spruce or a combination thereof. In some embodiments, the surface is a material comprising wood, carbon fiber, a synthetic material, or a combination thereof. Exemplary synthetic materials include polyethylene, polytetrafluoroethylene, Ptex, polyurethane, fiberglass, acrylonitrile butadiene styrene, honeycomb, epoxy resin, or a combination thereof.

In some examples, disclosed compositions are applied to the surface of winter sport equipment, e.g., the base of skis, snowboards, snowshoes, sleds, and toboggans. In other examples, disclosed compositions are applied to the surface of water sport equipment, e.g., surfboards, wakeboards, paddleboards, kiteboards, and windsurfboards. In additional examples, disclosed compositions are applied to a surface, such as a surface containing wood, to improve the appearance, feel, durability, water-resistance, dirt-resistance, stain-resistance, or lifespan thereof.

In other examples, disclosed curable wax compositions can be applied to outdoor camping equipment, upholstery, clothing, footwear, tents, awnings, backpacks, hiking boots, fishing waders, raincoats, and furniture. Disclosed curable wax compositions can be applied to natural skins or hides, e.g., leather, artificial, faux, or synthetic hides, e.g., faux leather and vegan leather, natural fibers, synthetic fibers, canvas, cotton, cotton blends, duck canvas, wax canvas, polyester, nylon, ripstop nylon, neoprene, nylon, PVC, brick, concrete, and metal surfaces.

In some examples, disclosed curable wax compositions can be rubbed or melted onto a surface, such as a porous material composed of wood. If rubbed, the composition should be heated to facilitate penetration into the pores of the surface. The wax may be allowed to cure upon exposure to sunlight or a UV lamp, such as a light emitting UVA, UVB, or light having a wavelength of 365-395 nm. In other examples, a catalyst, such as an MEKP catalyst may be used to facilitate curing, e.g., in the absence of sunlight or a UV lamp. In any of the preceding examples, alcohol can be used to thin the wax to the user's preference.

### EXAMPLES

### Example 1: Exemplary Curable Wax Paste and Manufacturing Thereof

A disclosed composition, such as a curable wax paste, includes four components: 1) a wax, 2) a UV hardener, 3) tung oil, and 4) a dissolution or hardening agent. An exemplary composition includes a natural wax or a natural wax blend, and a 1:1 mixture of tung oil and a citrus extract, such as citrus essential oil, as exemplified below in Table 1. Tung oil supplies the polymers needed for the curing agent to function as does the wax to a lesser degree.

TABLE 1
Exemplary Curable Wax Paste Ingredients

| Ingredient | Amount |
|---|---|
| Natural wax/Natural wax blend | 25-750 grams |
| Tung Oil | 10-100 ml |
| Orange Oil Limonene Extract (100% D- | 10-100 ml |
| limonene) | |
| UV Curing Agent or Catalyst | 1-10 ml/50 ml melt volume |

When a UV curing agent is unavailable a catalyst can be used instead, such as an MEKP catalyst. Graphene and/or graphite may be added to enhance wax features. The proportions of the ingredients provided in Table 1 should not be construed as limiting. Such proportions can be altered to optimize the wax for use in various conditions.

Manufacture: The ingredients in Table 1, except for the UV curing agent or catalyst, were heated to about 180° F. degrees, until the solid components melted and a uniform composition was achieved. The mixture was then cooled to approximately 140° F.-160° F. The UV curing agent or catalyst was then added to the cooled mixture. The resultant wax paste was then poured into a mold for packaging. Throughout the process, the components were not allowed to boil and were kept below approximately 212° F.

### Example 2: Application and Curing

Application: A disclosed composition is applied to the surface of a porous material, such as the base of a ski or snowboard. Once the surface is evenly coated, heat is applied to melt the composition, e.g., such that it seeps into the pores of the ski or snowboard. Material may be applied as needed to maintain an even coat while heated. Once a thin even coat is obtained the surface is allowed to cool to room temperature.

Curing: To cure the wax, the surface to which it has been applied is exposed to UV radiation, such as UVA, UVB, or light having a wavelength between 260-500 nm. In some examples, the wax is exposed to sunlight. In other examples, the wax is cured by exposure to a UV lamp. Alternatively, an MEKP catalyst, alcohol or 3% hydrogen can be applied to the wax to cure the composition. Alcohol can then be applied to polish the wax, even thickness and remove ridges created during application.

Alternative Methods: If a heat source is unavailable the wax may be rubbed on without heating and melting. In the absence of a catalyst, alcohol can be applied to optimize the surface properties of the wax, such as the thickness of uncured or UV-cured wax.

### Example 3: Field Test

A disclosed composition is tested against a control composition that lacks the polymerizable component, e.g., tung oil, but is otherwise identical to the tested disclosed composition. The test composition is applied to the base of one of a pair of skis and the control composition is applied to the base of the other. A skier evaluates the compositions by rating at least the parameters of grip, working temperature and snow humidity area, slip, icing properties, wear properties, dirt uptake from the snow, and application properties.

### Example 4: Shoe or Leather Care Wax

A curable wax condition according to the disclosure is applied to an animal hide or skin or a synthetic version thereof, e.g., leather, synthetic leather, nubuck, or suede. The wax is optionally cured, e.g., exposed to sunlight or a UV lamp. If a heat source is unavailable the wax may be rubbed onto the natural or synthetic hide without heating and melting. Regular application of the curable wax can significantly extend the life of hides, shoes, and other articles composed of natural and/or synthetic hides. Along with creating a protective layer that repels water, prevents stains, and water damage, the curable wax of the disclosure can protect from scratches, scuffs, and the wear-and-tear of daily use

I claim:

1. A curable wax composition comprising a drying oil, a monoterpene compound, and a natural wax, wherein the composition comprises the natural wax in an amount of 45-85% w/w relative to the total composition.

2. The composition of claim 1, further comprising a UV catalyst and/or an MEKP catalyst.

3. The composition of claim 1, wherein the drying oil comprises linseed oil, soybean oil, safflower oil, tung oil, or a combination thereof.

4. The composition of claim 1, wherein the natural wax comprises beeswax, soy wax, bayberry wax, candelilla wax, carnauba wax, castor wax, vegetable wax, ouricury wax, rice bran wax, or lanolin.

5. The composition of claim 1, wherein the composition comprises a natural wax blend.

6. The composition of claim 5, wherein the natural wax blend comprises a wax with a melting point of 145° F. to 200° F., wherein the range is inclusive.

7. The composition of claim 5, wherein the natural wax blend comprises any two or more of beeswax, soy wax, bayberry wax, candelilla wax, carnauba wax, castor wax, vegetable wax, ouricury wax, rice bran wax, and lanolin.

8. The composition of 1, wherein the monoterpene compound comprises camphor, citral, citronellol, geraniol, grapefruit mercaptan, eucalyptol, ocimene, myrcene, limonene, linalool, menthol, camphene, or pinene.

9. The composition of claim 1, wherein the composition further comprises graphene, graphene oxide, graphite, or a combination thereof.

10. The composition of claim 1, wherein the composition does not comprise per-and polyfluoroalkyl substances (PFAS).

11. A ski wax composition comprising:
a) 10-15% (w/w) tung oil;
b) 55-80% (w/w) of a natural wax blend;
c) 10-15% (w/w) limonene; and
d) 1-5% (w/w) of a UV catalyst.

12. The composition of claim 11, wherein the natural wax blend comprises any two or more of beeswax, soy wax, bayberry wax, candelilla wax, carnauba wax, castor wax, vegetable wax, ouricury wax, rice bran wax, and lanolin.

13. The composition of claim 11, wherein the natural wax blend comprises beeswax, soy wax, and carnauba wax.

14. The composition of claim 11, wherein the composition further comprises graphene, graphene oxide, graphite, or a combination thereof.

15. The composition of claim 11, wherein the composition does not comprise per- and polyfluoroalkyl substances (PFAS).
